(19) United States
(12) Patent Application Publication
(10) Pub. No.: US 2024/0113941 A1
(43) Pub. Date: Apr. 4, 2024

(54) Managing Cloud-Based Networks

(71) Applicant: Prosimo Inc., San Jose, CA (US)

(72) Inventors: Faraz Siddiqui, Mountain House, CA (US); Gaurav Thakur, San Jose, CA (US); Erick Moore, Zionville, IN (US)

(21) Appl. No.: 18/530,458

(22) Filed: Dec. 6, 2023

Related U.S. Application Data
(63) Continuation-in-part of application No. 17/315,192, filed on May 7, 2021.
Application No. 17/315,192 is a continuation-in-part of application No. 17/127,876, filed on Dec. 18, 2020.

(51) Int. Cl. H04L 41/0895; H04L 41/0803; H04L 41/122

(52) U.S. Cl. CPC H04L 41/0895; H04L 41/0803; H04L 41/122

(57) ABSTRACT

Edge clusters execute in a plurality of regional clouds of a cloud computing platforms, which may include cloud POPs. Edge clusters may be programmed to control access to applications executing in the cloud computing platform. A network object is created and represents network resources, such as IP addresses, subnetworks, or virtual networks. Permissions of one or more entities to access the network resources are associated with the network object. Identifiers of entities, including other network resources, are added to the network object to indicate network connections to the network resources. The edge clusters, and possibly one or more virtual networks, are configured by a network orchestrator according to the network object to implement the permissions and network connections.

### RELATED APPLICATION

This application a continuation-in-part of U.S. application Ser. No. 17/127,876, entitled “Managing Application Access Controls And Routing In Cloud Computing Platforms”, filed Dec. 18, 2020, the disclosure of which is incorporated by reference herein in its entirety.

This application is also a continuation-in-part of U.S. application Ser. No. 17/315,192, entitled “MANAGING ACCESS TO CLOUD-HOSTED APPLICATIONS USING DOMAIN NAME RESOLUTION,” filed May 7, 2021, the disclosure of which is incorporated by reference herein in its entirety.

### FIELD OF THE INVENTION

The present invention relates generally to systems and methods for implementing enterprise security with respect to applications hosted on a cloud computing platform.

### BACKGROUND OF THE INVENTION

Currently there is a trend to relocate applications, databases, and network services to cloud computing platforms. Cloud computing platforms relieve the user of the burden of acquiring, setting up, and managing hardware. Cloud computing platforms may provide access across the world, enabling an enterprise to operate throughout the world without needing a physical footprint at any particular location.

However, implementing a security perimeter for a cloud computing platform becomes a much more complex problem than when hosting on premise equipment. For example, an enterprise may host applications on multiple cloud computing platforms that must all be managed. Authenticating users of applications according to a coherent policy in such diverse environment is difficult using current approaches. These problems are further complicated when users of the applications of an enterprise are accessing the applications from diverse locations across the globe.

It would be an advancement in the art to implement an improved solution for managing access to applications hosted in a cloud computing platform.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment for managing access to cloud-based applications in accordance with an embodiment of the present invention;

FIG. 2 is a schematic block diagram of components for managing access to cloud-based applications in accordance with an embodiment of the present invention;

FIG. 3 is a process flow diagram of a method for performing managing access to an application using domain name resolution in accordance with an embodiment of the present invention;

FIG. 4 is a schematic block diagram of components for performing domain name resolution in a cloud computing platform in accordance with an embodiment of the present invention;

FIG. 5 is a process flow diagram of a method for performing domain name resolution in a cloud computing platform in accordance with an embodiment of the present invention;

FIG. 6 is a table illustrating different routing options with respect to a cloud computing platform in accordance with an embodiment of the present invention;

FIG. 7 is a process flow diagram of a method for implementing different routing options with respect to a cloud computing platform in accordance with an embodiment of the present invention;

FIG. 8 is a process flow diagram of a method for implementing routing with respect to a cloud computing platform according to cacheability in accordance with an embodiment of the present invention;

FIGS. 9A and 9B illustrate different routing configurations according to cacheability in accordance with an embodiment of the present invention;

FIG. 10 is a schematic diagram illustrating an approach for managing network access and resources using a network object in accordance with an embodiment of the present invention;

FIG. 11 is a schematic diagram of a network hierarchy defined using network objects in accordance with an embodiment of the present invention;

FIG. 12 is a process flow diagram of a method for creating a network object in accordance with an embodiment of the present invention;

FIG. 13 is a process flow diagram of a method for associating entities with a network object in accordance with an embodiment of the present invention;

FIG. 14 is a process flow diagram of a method for removing entities from association with a network object in accordance with an embodiment of the present invention;

FIG. 15 is a schematic block diagram of a roll-based access control (RBAC) hierarchy;

FIG. 16 is a process flow diagram of a method for granting permission according to the RBAC hierarchy; and

FIG. 17 is a schematic block diagram of a computing device that may be used to implement the systems and methods described herein.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

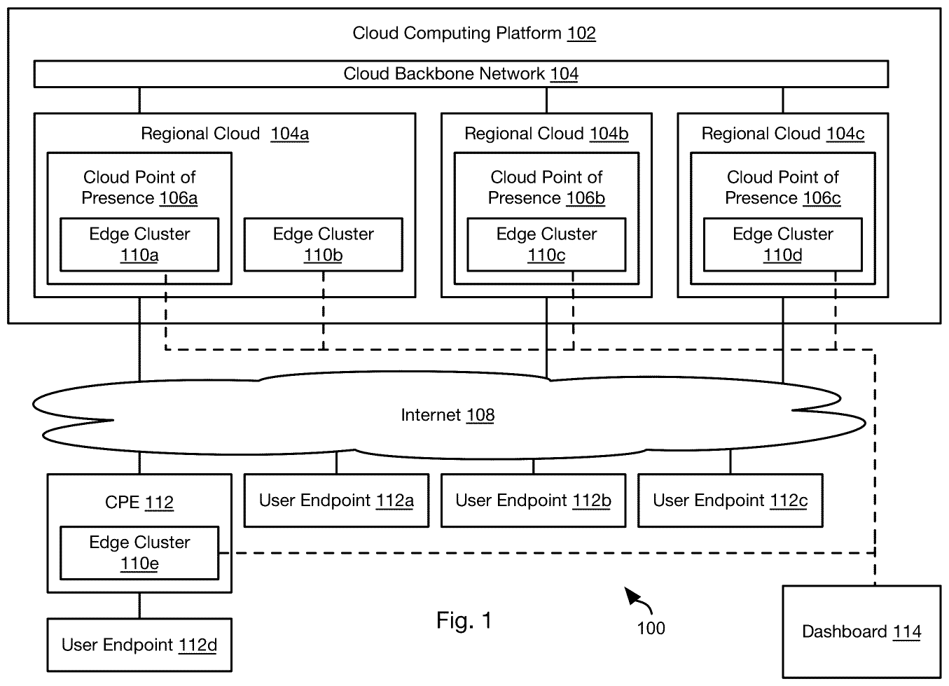

Referring to FIG. 1, a network environment may include one or more cloud computing platforms 102, such as AMAZON WEB SERVICES (AWS), MICROSOFT AZURE, GOOGLE CLOUD PLATFORM, or the like. As will be discussed below, multiple cloud computing platforms 102 from multiple providers may be used simultaneously. As known in the art, a cloud computing platform 102 may be embodied as a set of computing devices coupled to networking hardware and providing virtualized computing and storage resources such that a user may instantiate and execute applications, implement virtual networks, and allocate and access storage without awareness of the underling computing devices and network hardware. Each cloud computing platform 102 may implement some or all aspects of the cloud computing model described above. One or more of the cloud computing platforms 102 may be a public cloud providing cloud computing services to multiple entities for a fee. One or more of the cloud computing platforms 102 may also be a private cloud computing platform built and maintained on a premise of the entity utilizing the private cloud computing platform 102. In some implementations, systems and methods described herein may be implemented by a combination of one or more public private cloud computing platforms 102 and one or more private cloud computing platforms 102.

A cloud computing platform 102 from the same provider may be divided into different regional clouds, each regional cloud including a set of computing devices in or associated with a geographic region and connected by a regional network. These regional clouds may be connected to one another by a cloud backbone network 104. The cloud backbone network 104 may provide high throughput and low latency network connections for traffic among a plurality of regional clouds 104a-104c. The cloud backbone network 104 may include routers, switches, servers and/or other networking components connected by high capacity fiber optic networks, such as transoceanic fiber optic cables, the Internet backbone, or other high-speed network. Each regional cloud 104a-104c may include cloud computing devices and networking hardware located in and/or processing traffic from a particular geographic region, such as a country, state, continent, or other arbitrarily defined geographic region.

A regional cloud 104a-104c may include one or more points of presence (POPs) 106a-106c. For example, each regional cloud 104a-104c may include at least one POP 106a-106c. A cloud POP 106a-106c may be a physical location hosting physical network hardware that implements an interface with an external network, such as a wide area network (WAN) that is external to the cloud computing platform 102. The WAN may, for example, be the Internet 108. A WAN may further include a 5G Cellular Network and/or a LONG TERM EVOLUTION (LTE) cellular network.

For example, a high-speed, high-capacity network connection of an Internet service provider (ISP) may connect to the POP 106a-106c. For example, the network connection may be a T1 line, leased line, fiber optic cable, Fat Pipe, or other type of network connection. The POP 106a-106c may have a large amount of servers and networking equipment physically at the POP 106a-106c enabled to handle network traffic to and from the network connection and possibly providing computing and storage at the POP 106a-106c.

The POP 106a-106c therefore enables users to communicate with the cloud computing platform 102 very efficiently and with low latency. A cloud computing platform 102 may implement other entrance points from the Internet 108 in a particular regional cloud 104a-104c. However, a POP 106a-106c may be characterized as providing particularly low latency as compared to other entrance points.

Edge clusters 110a-110c may execute throughout a cloud computing platform 102. Edge clusters 110a-110c may operate as a cooperative fabric for providing authenticated access to applications and performing other functions as described herein below. Edge clusters 110a, 110c, 110d may be advantageously hosted at a cloud POP 106a-106c. Edge clusters 110b may also be implemented at another location within a cloud computing platform 102 other than a cloud POP 106a-106c. In some instances, one or more edge cluster 110e may also execute on customer premise equipment (CPE) 112. One or more edge cluster 110e on CPE 112 may be part of a fabric including one or more edge clusters 110a-110d executing in a cloud computing platform 102. Edge clusters 110a-110d on cloud computing platforms 102 of different providers may also form a single fabric functioning according to the functions described herein below.

Each edge cluster 110a-110e may be implemented as a cluster of cooperating instances of an application. For example, each edge cluster 110a-110e may be implemented as a KUBERNETES cluster managed by a KUBERNETES master, such that the cluster includes one or pods, each pod managing one or more containers each executing an application instance implementing an edge cluster 110a-110e as described herein below. As known in the art, a KUBERNETES provide a platform for instantiating, recovering, load balancing, scaling up, and scaling down, an application including multiple application instances. Accordingly, the functions of an edge cluster 110a-110c as described herein may be implemented by multiple application instances with management and scaling up and scaling down of the number of application instances being managed by a KUBERNETES master or other orchestration platform.

Users of a fabric implemented for an enterprise may connect to the edge clusters 110a-110e from endpoints 112a-112d, each endpoint being any of a smartphone, tablet computer, laptop computer, desktop computer, or other computing device. Devices 110a-110a may connect to the edge clusters 110a-110e by way of the Internet or a local area network (LAN) in the case of an edge cluster hosted on CPE 112.

Coordination of the functions of the edge clusters 110a-110e to operate as a fabric may be managed by a dashboard 114. The dashboard 114 may provide an interface for configuring the edge clusters 110a-110e and monitoring functioning of the edge clusters 110a-110e. Edge clusters 110a-110e may also communicate directly to one another in order to exchange configuration information and to route traffic through the fabric implemented by the edge clusters 110a-110e.

In the following description, the following conventions may be understood: reference to a specific entity (POP 106a, edge cluster 110a, endpoint 112a) shall be understood to be applicable to any other instances of that entity (POPs 106b-106c, edge clusters 110b-110e, endpoints 112b-112d). Likewise, examples referring to interaction between an entity and another entity (e.g., an edge cluster 110a and an endpoint 112a, an edge cluster 110a and another edge cluster 110b, etc.) shall be understood to be applicable to any other pair of entities having the same type or types. Unless specifically ascribed to an edge cluster 110a-110e or other entity, the entity implementing the systems and methods described herein shall be understood to be the dashboard 114 and the computing device or cloud computing platform 102 hosting the dashboard 114.

Although a single cloud computing platform 102 is shown, there may be multiple cloud computing platforms 102, each with a cloud backbone network 104 and one or more regional clouds 104a-104c. Edge clusters 110a-110e may be instantiated across these multiple cloud computing platforms and communicate with one another to perform cross-platform routing of access requests and implementation of a unified security policy across multiple cloud computing platforms 102.

Where multiple cloud computing platforms 102 are used, a multi-cloud backbone 104 may be understood to be defined as routing across the cloud backbone networks 104 of multiple cloud computing platforms 102 with hops between cloud computing platforms being performed over the Internet 108 or other WAN that is not part of the cloud computing platforms 102. Hops may be made short, e.g., no more than 50 km, in order to reduce latency. As used herein, reference to routing traffic over a cloud backbone network 104 may be understood to be implementable in the same manner over a multi-cloud backbone as described above.

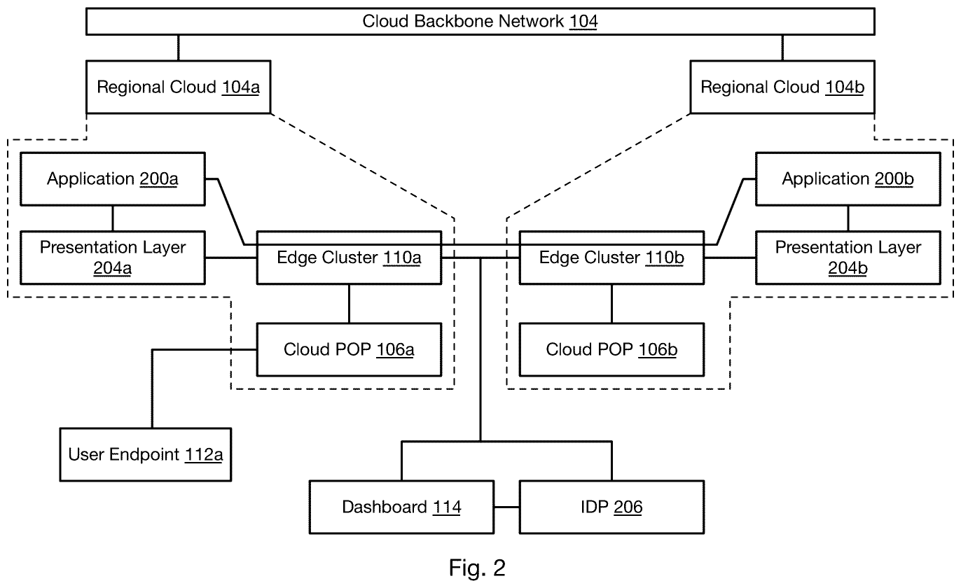

FIG. 2 illustrates an example approach for managing application instances 200a-200b of an enterprise that are managed by a fabric implemented by a fabric including edge clusters 110a, 110b. Each edge cluster 110a, 110b may be in a different regional cloud 104a, 104b of a cloud computing platform 102, each regional cloud 104a, 104b being connected to the cloud backbone network 104 of that cloud computing platform 102. In the illustrated example, each edge cluster 110a, 110b executes within a cloud POP 106a, 106b of each regional cloud 104a, 104b, respectively. In other implementations, one or both of the edge clusters 110a, 110b is not executing within the cloud POP 106a, 106b of the regional cloud 104a, 104b by which it is executed.

Each application instance 200a, 200b may have a corresponding presentation layer 204a, 204b. The presentation layer 204a, 204b may, for example, be a web interface by which an interface to the application instance 200a, 200b is generated and transmitted to a user endpoint 112a and by which interactions received from the user endpoint 112a are received and processed by the application instance 200a, 200b. The presentation layer 204a, 204b may also be a graphical user interface (GUI) native to a computing platform simulated b the cloud computing platform 102, the GUI being transmitted to the endpoint 112a and interactions with the GUI being received from the user endpoint 112a and submitted to the application instance 200a, 200b by the GUI. In yet another alternative, the presentation layer 204a, 204b is a module programmed to communicate with a client executing on the user endpoint 112a in order to transmit information to the endpoint 112a and receive user interactions from the user endpoint 112a.

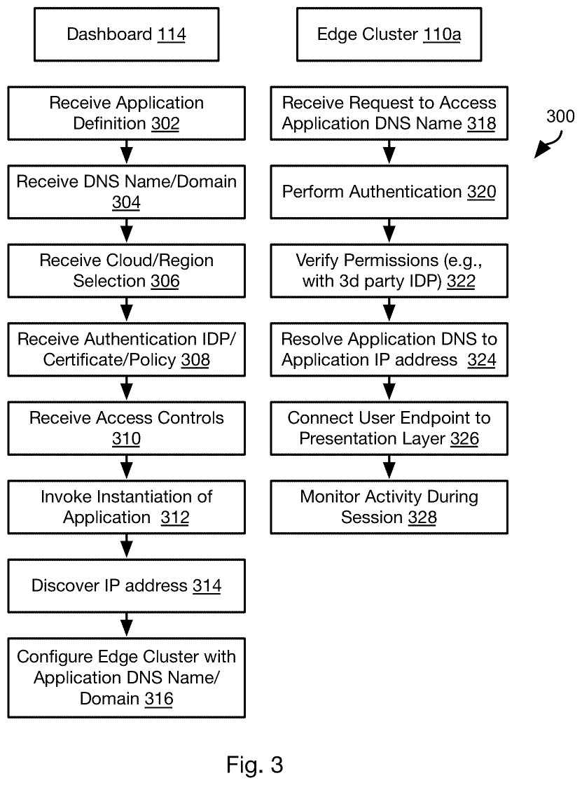

The edge clusters 110a, 110b may act as a gateway to the presentation layers 204a, 204b and provide access to the presentation layers 204a, 204b only to authenticated users. An example approach implemented by the edge clusters 110a, 110b is described below with respect to FIG. 3. The edge clusters 110a, 110b may be configured by the dashboard 114. The dashboard 114 may incorporate or cooperate with an identity provider (IDP) 206 such as OKTA, ONELOGIN, CENTRIFY, EMPOWERID, OPTIMAL IDM, BITIUM, LAST PASS, and PINGIDENTITY. Alternatively, the IDP 206 may be a cloud provider or a vendor providing virtual machines (e.g., VMWARE) within which the edge clusters 110a, 110b and application instances 200a, 200b are executing.

As shown in FIG. 2, application instances 200a, 200b may communicate with one another as part of their functionality. In some instances, this communication may be routed by way of the edge clusters 110a, 110b of the fabric managing the application instances 200a, 200b.

Referring to FIG. 3, the instances of an application 200a, 200b (hereinafter only application instance 200a is discussed) may be instantiated and access thereto controlled using the illustrated method 300.

The method 300 may include receiving 302, such as by the dashboard 114, an application definition. The application definition may be received from an administrator, a script, or from another source. The application definition may specify an executable of which the application instance 200a will be an instance, configuration parameters for an instance of the executable, or other configuration information. The dashboard 114 may further receive 304 one or both of a name and a domain in a like manner. The name and/or domain may be according to a DNS (domain name service). As discussed in greater detail below, the dashboard 114 and edge clusters 110a-110e may implement DNS internal to the fabric managed by the edge clusters 110a-110e. Accordingly, the DNS may manage mapping of names and domains to actual addresses, e.g. IP addresses, of application instances in one or more cloud computing platforms 102 and one or more regional clouds 104a, 104b of one or more cloud computing platforms 102.

The method 300 may include receiving 306 selection of a cloud computing platform 102 and possibly selection of a particular regional cloud 104a, 104b, e.g. California, USA regional cloud for the AWS cloud computing platform 102. The selection of step 306 may be received from an administrator, read from a configuration script, or received from another source. In some implementations, this step is omitted and the dashboard 114 automatically selects a cloud computing platform 102 and possibly a regional cloud 104a, 104b. In yet another alternative, only a cloud computing platform 102 is selected and the cloud computing platform 102 automatically selects a regional cloud 104a, 104b.

The method 300 may include receiving 308 a definition of some or all of an IDP 206 to use for controlling access to the application instance 200a, an authentication certificate associated with the application instance 200a for use in authenticating users with the application instance 200a, and an authentication policy governing access to the application instance 200a (e.g., user accounts, groups, or the like that may access the application instance 200a). The information of step 308 may be received from an administrator, read from a configuration script, or received from another source.

The method 300 may include receiving 310 access controls. The access controls may be received from an administrator, read from a configuration script, or received from another source. The access controls may include some or all of time-based limitations (times of day, days of the week, etc. during which the application instance 200a may be accessed), location-based limitations (locations from which endpoints 110a-110d may access the application instance), a requirement for two-factor authentication, etc., or other type of access control.

The method 300 may further include invoking 312 instantiating an instance of the executable specified at step 302 as the application instance 200a in the cloud computing platform 102, and possibly regional cloud, specified at step 306. For example, the cloud computing platform 102 may provide an interface for instantiating application instances on virtualized computing resources. Accordingly, step 312 may include invoking this functionality to cause the cloud computing platform 102 or other tool to instantiate an application instance 200a. In some embodiments, the application instance 200a already exists such that step 312 is omitted and one or more edge clusters 110a-110e are configured to manage access to the application instance 200a.

The method 300 may include discovering 314 an internet protocol (IP) address of the application instance 200a. For example, in response to an instruction to create the application instance 200a, the cloud computing platform 102 may create the application instance 200a and assign an IP address to the application instance 200a. The cloud computing platform 102 may then return the IP address to the entity that requested instantiation, which may be the dashboard 114 in the illustrated example.

The method 300 may further include the dashboard 114 configuring 316 one or more edge clusters 110a-110e of the fabric to manage access to the application instance 200a. This may include storing a link between the name and/or domain from step 304 with the IP address from step 314 by the DNS. In some embodiments, the name and/or domain from step 304 may be distributed to endpoints 110a-110e whereas the IP address is not. Accordingly, the edge clusters 110a-110e may function as DNS servers and further control access to the application instance 200a by refraining from forwarding traffic to the IP address until a source of the traffic has been properly authenticated.

Step 316 may further include configuring one or more edge clusters 110a-110e of the fabric according to the authentication requirements of step 308 and the access controls of step 310. For example, one or more edge clusters 110a-110e may be programmed to condition allowance of a request to access the application instance 200a on some or all of (a) receiving confirmation from the specified IDP 206 that a source of the request is authenticated, (b) verifying a certificate submitted with the request according to a certificate received at step 308, (c) verifying that the request was received according to the access controls of step 310 (from a permitted location, at a permitted time, etc.).

An edge cluster 110a configured as described above with respect to step 316 may receive 318 a request to access the application instance 200a from an endpoint 112a, the request including the name and/or domain of the application instance 200a.

The edge cluster 110a may perform 320 authentication of the request and/or the endpoint 112a. This may include instructing the endpoint 112a to authenticate with the IDP 206 and receiving verification from the IDP 206 that the endpoint 112a is authenticated, such as authenticated for a particular user identifier. Step 320 may include authentication by another approach such as verification of a user identifier and password, verification of a certificate, or other authentication means.

If authentication is not successful at step 320, the remainder of the steps of the method 300 may be omitted and the request may be ignored, recorded, flagged as potentially malicious, or subject to other remedial action.

In response to successful authentication at step 320, the edge cluster 110a may resolve the name and/or domain of the request to the IP address mapped to it at step 316 and connect 326 the user endpoint 112a to the application instance. Connection may include establishing a network connection to the application instance 200a. The edge cluster 200a may implement network address translation (NAT) such that the IP address is not disclosed to the user endpoint 112a. Accordingly, a different IP address, such as the address of the edge cluster 200a, may be used as the destination of traffic sent by the user endpoint 112a and the edge cluster 200a may route the traffic to the IP address of the application instance 200a using NAT 200a and forward the traffic to the application instance 200a.

In some embodiments, the edge cluster 110a may monitor activities of the user endpoint 112a with respect to the application instance 200a and block further access in response to suspicious activity. Examples of suspicious activity may include access patterns that are different from past access by the endpoint 112a: access from a different country, a different time of day, an unusually high volume of traffic, or the like. The edge cluster 110a may therefore compile information of typical access patterns for the edge cluster 110a in order to detect anomalous access patterns.

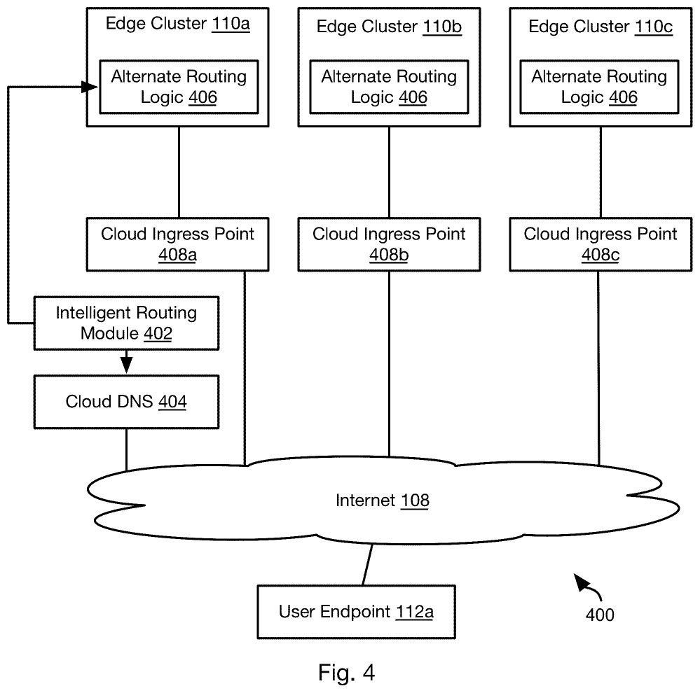

FIG. 4 illustrates a system 400 that may be implemented by a fabric of edge clusters 110a-110c in a network environment, such as the network environment 100. In the illustrated system, an intelligent routing module 402 programs cloud DNS 404 of a cloud computing platform 102. The intelligent routing module 402 may be a component within the dashboard 114 or managed in response to user instructions input to the dashboard 114. The cloud DNS 404 may control the routing of traffic received from the user endpoint 112a among various ingress points 408a-408c of the cloud computing platform 102. The ingress points 408a-408c may include ingress points to different regional clouds and/or different ingress points to the same regional cloud.

A user endpoint 112a may transmit a request to a cloud computing platform 102 over the Internet 108. The request may be a request to access a resource name, such as in the form of a URL including a domain name and possibly one or more other items of information, such as a sub-domain, computer name, and possibly one or more other items of identifying information of a requested resource. The resource name may reference an application instance 200a and may include a name and domain configured for the application instance 200a as described above with respect to step 304 of the method 300.

The cloud DNS 404 may receive the request and resolve the resource name to an address, such as an IP address, assigned to one or more of the edge clusters 110a-110c implementing a fabric. The resolution by the cloud DNS 404 may be according to programming of the cloud DNS 404 by the intelligent routing module 402. Accordingly, a resource name may be associated by the intelligent routing module 402 to any edge cluster 110a-110e of a fabric. The cloud DNS 404 may implement Anycast DNS whereby the routing of a request is conditioned on a location of the user endpoint 112a that issued the request.

In some implementations, an edge cluster 110a-110c of a fabric may implement alternative routing logic 406. A request received by an edge cluster 110a may be evaluated according to the alternative routing logic 406, which may instruct the edge cluster 110a to instruct the endpoint 112a that generated the request to resubmit the request to a different edge cluster 110b. For example, the alternative routing logic 406 may transmit alternative service (“Alt-Svc”) messages according to hypertext transport protocol (HTTP). In some implementations, the cloud DNS 404 may be incapable of fine-grained routing of requests. For example, there may be edge clusters 110a-110c at various geographic locations in a regional cloud whereas the cloud DNS 404 only enables a user to perform geographic name resolution to a single address within each regional cloud. Accordingly, the intelligent routing module 402 may program the cloud DNS to route requests to an edge cluster 110a in a regional cloud. The intelligent routing module 402 may further configure the alternate routing logic 406 of that edge cluster 110a to evaluate the location of user endpoints 112a and route requests from that user endpoint 112a to another edge cluster 110b in that regional cloud. For example, edge cluster 110b may be closer to the user endpoint 112a then the edge cluster 110a.

The system 400 may be used to perform arbitrary routing of traffic between a user endpoint 112a and any of the edge clusters 110a-110c. Various applications of the system 400 are described herein below.

For example, an edge cluster 110a-110e may be associated with the name and/or domain assigned to the application instance 200a in the cloud DNS 404 and/or alternative routing logic 406 such that requests addressed to the name and/or domain of the application instance 200a will be routed according to the static IP address or Anycast IP address of associated with the edge cluster 110a-110e for the application instance 200a. In another example, a request to resolve the name and/or domain of an application instance 200a may be resolved by the cloud DNS 404 and or alternative routing logic 406 to an IP address that may be a static IP address of a particular edge cluster 110a-110e or an Anycast IP address that could be resolved to one of multiple edge clusters 110a-110e.

The source of the resolution request may then transmit a request to the IP address returned to it, with the request being routed according to functionality associated with that IP address (static routing or Anycast routing).

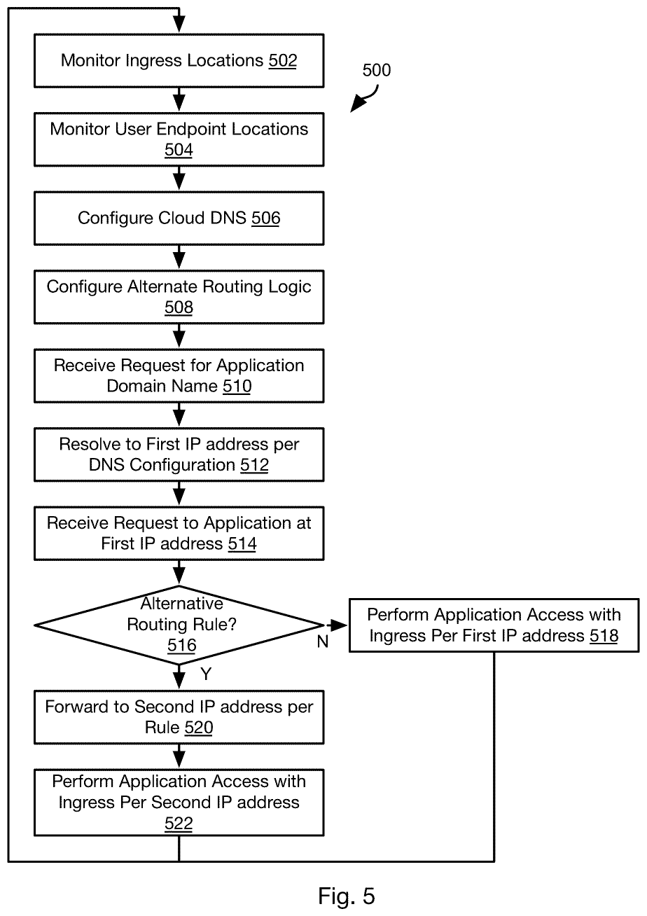

FIG. 5 illustrates a method 500 of performing routing using the system 400. The method 500 may be performed by the intelligent routing module 402 and/or dashboard 114.

The method 500 may include monitoring 502 ingress locations. This may include tracking ingress locations 408a-408c of a cloud computing platform 102 at which requests from user endpoints 112a-112d are received. Monitoring 502 may include compiling statistics such as a frequency of requests for a given ingress points 408a-408c (requests per hour, minute, or other time interval) over time. The ingress point 408a-408c of requests may be detected due to reporting by the cloud computing platform 102, by the edge cluster 110a-110d that received a request recording an ingress point 408a-408c through which the request was received, or by some other means.

The method 500 may further include monitoring 504 the locations of user endpoints 112a-112d from which requests were received. The location of an endpoint 112a-112d at a time of generation of a request may be obtained by: inferring a location from a source IP address of the request, reading the location from a header included in the request, reading the location from an explicitly provided location value provided by the endpoint 112a-112d within the request. Monitoring 504 the locations may include some or all of compiling statistics for each location represented in received requests at varying degrees of specificity: requests from a country, from each state or province within the country, from each metropolitan area within the country, within each city within the country, etc. Statistics may be in the form of a frequency of requests (requests per day, hour, minute, or other time window) over time.

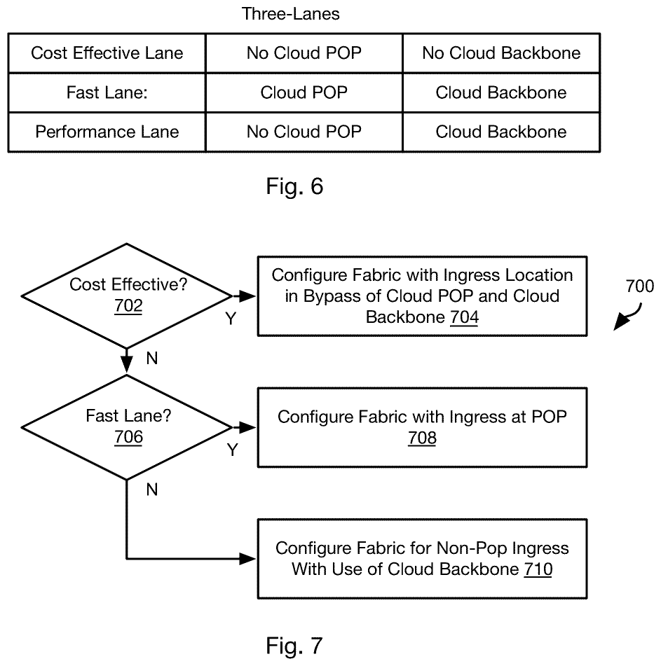

The method 500 may include configuring 506 the cloud DNS 404 and/or configuring 508 alternate routing logic 406 according to the data obtained from the monitoring steps 502, 504. Example approaches for configuring routing of requests for a fabric of edge cluster 110a-110e according to usage data are described below with respect to FIGS. 6 through 1B.

The method 500 may include receiving 510 an original request from user endpoint 110a to resolve a name and/or domain of the application instance 200a. The original request may be a domain resolution request or a request to access the application instance 200a including the name and/or domain. The original request may be received by the cloud DNS 404. In response to the programming of step 506, the cloud DNS 404 resolves 512 the name and/or domain to an IP address of an edge cluster, e.g., edge cluster 110a. The user endpoint 110a may receive this IP address from the cloud DNS 404 and transmit a second request to access the application instance 200a to the IP address of the edge cluster 110a. Alternatively, the cloud DNS 404 may forward the original request to the IP address.

Resolving 512 the domain name to an IP address may include using any of the approaches described above with respect to FIG. 4. These may include resolving the IP address to an Anycast IP address, resolving the IP address using geographic domain name service (GeoDNS) to a static or Anycast IP address, or resolving of the IP address to an Anycast IP address or static IP address followed by using alternative routing logic to redirect a request to an alternative edge cluster 110a-110e.

The edge cluster 110a receives 514 the request to access the application instance 200a (the original request forwarded by cloud DNS 404 or the second request from the user endpoint 112a). The edge cluster 110a may evaluated 516 whether there is alternative routing logic 406 applicable to the request. For example, the alternative routing logic may map a routing rule to one or both of the application instance 200a and one or more locations of user end points. Accordingly, step 516 may include determining whether the location of the user endpoint 112a and/or application instance 200a are referenced by a routing rule and if not, facilitates application access through the edge cluster 110a. This may include routing traffic through an ingress point 408a-408c of the cloud computing platform associated with the edge cluster 110a, e.g. an ingress point 408a-408c determined according to programming of the cloud DNS 404. If so, the method 500 may include the edge cluster 110a forwarding 520 the request to a second IP address, e.g. the IP address of a second edge cluster 110b having a different ingress location to the cloud computing platform in the same or different regional cloud. Redirecting may include one or both of the edge cluster 110a forwarding the request to the second edge cluster 110b and the edge cluster 110a transmitting the second IP address of the second edge cluster 110b to the user endpoint 112a with an instruction to access the application instance 200a at the second IP address. The user endpoint 112a may thereafter perform 522 application access (e.g., send access requests to and receive responses from the application instance 200a) through an ingress 408a-408c corresponding to the second IP address, such has an ingress location 408a-408c that is physically closest to a computing device executing the second edge cluster 112b. Selection of the ingress location 408a-408c for a given IP address may be performed by the cloud DNS 404 or by other routing logic. For example, traffic addressed to the IP address may be routed by the Internet 108 to the ingress location 408a-408c according to DNS information provided to routing devices of the Internet 108 by the cloud computing platform 102.

Referring to FIGS. 6 and 7, routing of requests, such as using the DNS system 400, may be performed to take into the account latency and cost. Referring specifically to FIG. 6, routing options may be grouped into “lanes,” including a cost effective lane, fast lane, and performance lane. The cost effective lane avoids ingress locations at cloud POPs 106a-106c and routing of traffic over the cloud backbone 104 inasmuch as there may be additional charges for such usage. The cost effective lane may reduce at the expense of higher latency. The fast lane may include an ingress location at a cloud POP 106a-106c (e.g., the cloud POP 106a-106c closest to the user endpoint 112a generating a request) with intra-cloud traffic being routed over the cloud backbone 104. The fast lane may provide reduced latency at increased cost from utilization of the POPs 106a-106c and cloud backbone 104. The performance lane may provide an intermediate level of latency and cost by using an ingress location other than a cloud POP 106a-106c while still routing intra cloud traffic over the cloud backbone 104.

The lane used may be a user-configurable parameter. For example, a particular application instance 200a may be assigned to a lane such that the intelligent routing module 402 will program the cloud DNS 404 and/or alternative routing logic 406 to route requests to that application instance 200a according to that lane. Application instances may be assigned to lanes individually, as a group (e.g., all instances of the same executable). Lanes may be additionally or alternatively be assigned to users or groups of users. For example, all requests from a user or group may be routed according to a particular lane or a combination. In another example, a particular combination of user and application instance may be assigned to a particular lane.

Referring to FIG. 7, the illustrated method 700 may be used by the intelligent routing module 402 to implement the three lanes, or other number of lanes. If the lane for a user and/or application instance is found 702 to be the cost effective lane, the intelligent routing module 402 configures 704 the fabric to bypass cloud POPs 106a-106c and the cloud backbone 104. For example, for an application instance 200a in a first regional cloud, requests to access the application instance 200a may be routed over the Internet 108 to an ingress point that is not a POP 106a-106c, including requests that are closer to a second regional cloud than to the first regional cloud. This configuration may include assigning an edge cluster 110a in the first regional cloud a static IP address that is not an Anycast IP address. In this manner, traffic addressed to the application instance will be routed to the static IP address over the Internet 108 rather than through a cloud POP 106a-106c or the cloud backbone 104. For example, step 704 may include programming GeoDNS of a cloud computing platform 102 to resolve a domain name to a static IP address for a given location of a user endpoint 112a-112d that results in bypass of POPs 106a-106c of the cloud computing platform 102.

If the lane for a user and/or application instance 200a is found 706 to be the fast lane, the intelligent routing module 402 may configure 708 the fabric such that ingress is performed at a cloud POP 106a-106c with use of the cloud backbone for intra-cloud traffic. This may include associating the name and/or domain of the application instance with an edge cluster 110a located within a cloud POP 106a-106c. The edge cluster 110a may be assigned an Anycast IP address in the cloud DNS 404. In this manner, traffic from user endpoints 112a-112d located nearer to a different regional cloud than that hosting the edge cluster 110a would be routed to a nearest POP 106a-106c and then over the cloud backbone 104 to the POP 106a-106c hosting the edge cluster 110a. User endpoints 112a-112d located nearer to the same regional cloud hosting the edge cluster 110a than other regional clouds of the cloud computing platform, may be routed over the Internet 108 to the POP 106a-106c hosting the edge cluster 110a.

If the lane for a user and/or application instance 200a is the performance lane, the intelligent routing module 402 may configure the fabric such that ingress is performed at a cloud POP 106a-106c without use of the cloud backbone for intra-cloud traffic. This may include associating the name and/or domain of the application instance with an edge cluster 110a located within a cloud POP 106a-106c. The edge cluster 110a may be assigned a static IP address (not Anycast) in the cloud DNS 404. The static IP address may be resolved from a domain name of a request according to the location of a user endpoint 112a-112d that generated the request. The resolution to the static IP address according to user endpoint 112a-112d location may be programmed into the GeoDNS of the cloud computing platform 102.

In this manner, traffic from user endpoints 112a-112d located nearer to a different regional cloud than that hosting the edge cluster 110a would be routed over the Internet 108 to the POP 106a-106c hosting the edge cluster 110a rather than over the cloud backbone 104. User endpoints 112a-112d located nearer to the same regional cloud hosting the edge cluster 110a than other regional clouds of the cloud computing platform, may be routed over the Internet 108 to the POP 106a-106c hosting the edge cluster 110a.

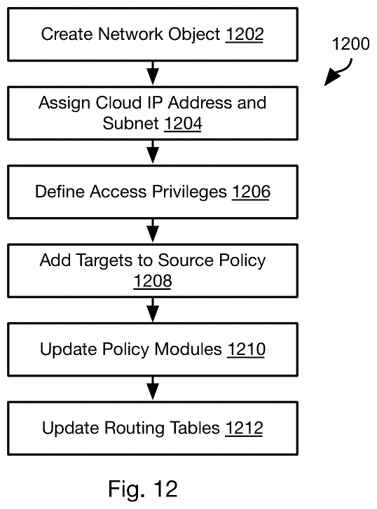

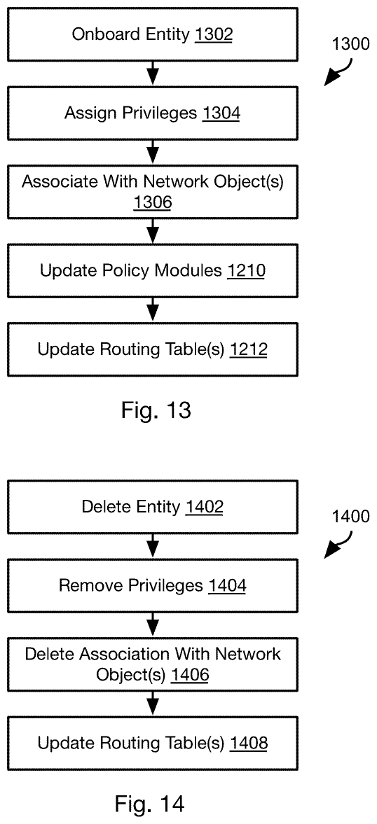

Note that in some instances, the benefit of one of the three lanes relative to another may be small. Accordingly, in some embodiments, a user preference may be overridden and substituted for a lower cost option when this occurs. For example, if a measured or estimated (see estimation techniques described below with respect to FIGS. 12 and 13) latency of a user endpoint 112a-112e with respect to an application instance 200 for one lane is within a threshold difference (e.g., a predefined number of miliseconds) of the latency for a second lane and the second lane has lower cost, the second lane may be substituted for routing traffic between the user endpoint 112a-112e.

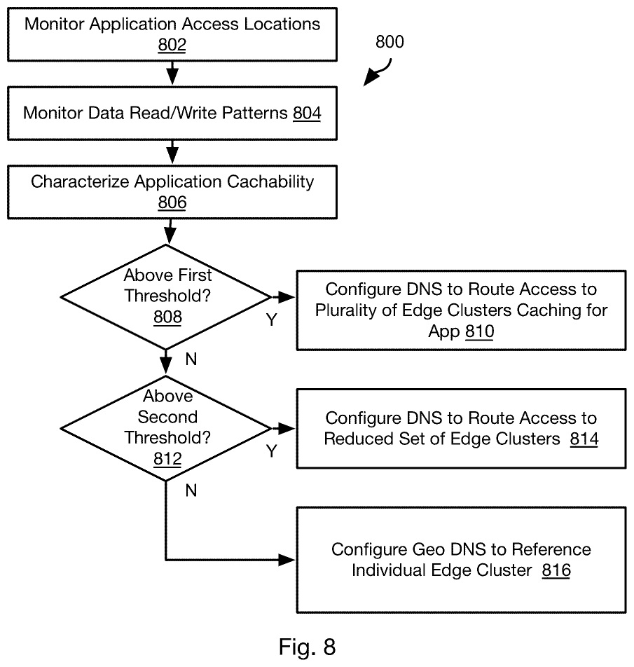

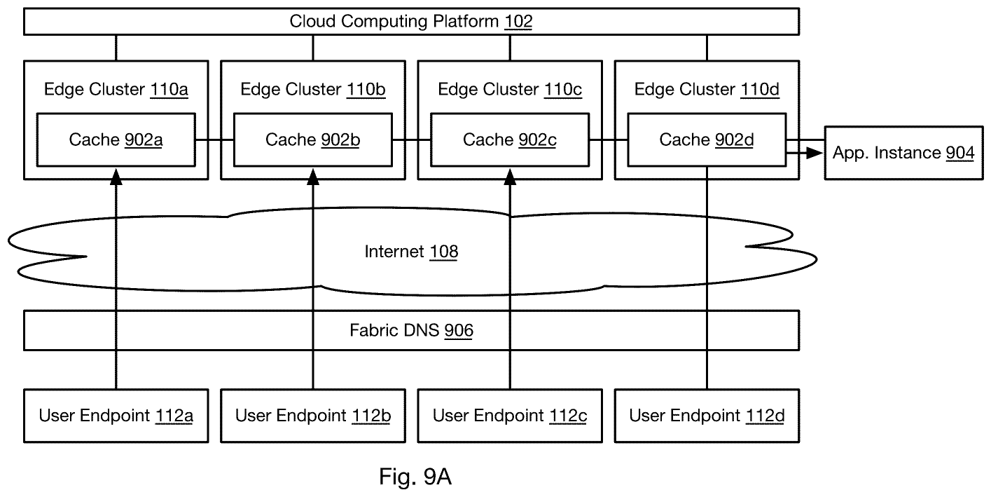

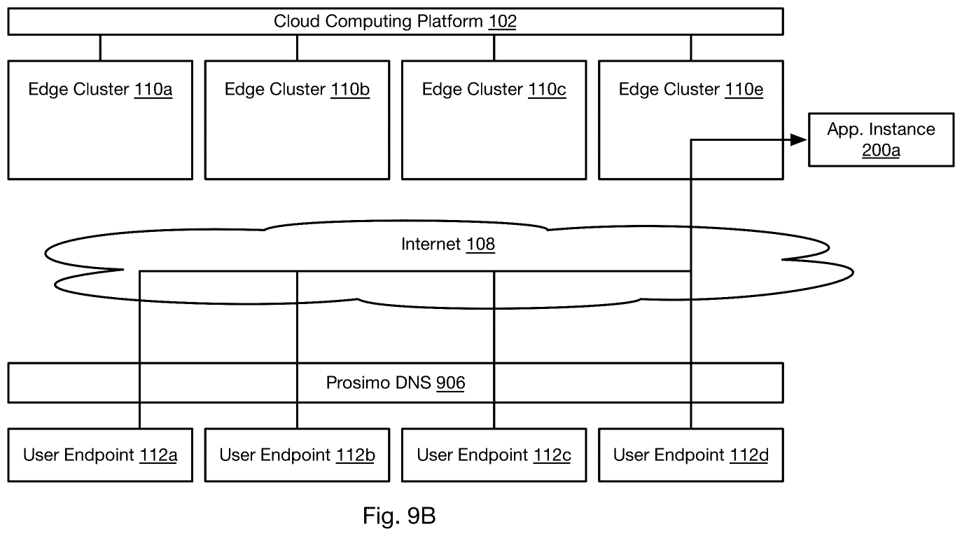

FIGS. 8, 9A, and 9B illustrate an approach for routing traffic for an application instance 200a to edge clusters 110a-110e of a fabric while taking into account cacheability of content provided by that application instance 200a.

For example, a method 800 may include monitoring 802 application access locations of user endpoints 112a-112e accessing the application instance 200a. The location of an endpoint 112a-112d at a time of generation of a request may be obtained by: inferring a location from a source IP address of the request, reading the location from a header included in the request, reading the location from an explicitly provided location value provided by the endpoint 112a-112d within the request. Monitoring 802 the locations may include some or all of compiling statistics for each location represented in received requests at varying degrees of specificity: requests from a country, from each state or province within the country, from each metropolitan area within the country, within each city within the country, etc. Statistics may be in the form of a frequency of requests (requests per day, hour, minute, or other time window) over time.

The method 800 may further include monitoring 804 data read and write patterns 804. This may include monitoring a cache for the application instance. Monitoring read and write patterns 804 may include monitoring a rate at which entries in a cache are overwritten or marked as invalid by the application 200a. Monitoring read and write patterns 804 may include inspecting requests and compiling statistics regarding the number of read requests and write requests, e.g. a number of write requests within a time window (e.g., every day, hour, minute, etc.) and a number of read requests within the time window sampled periodically over time. Step 804 may include calculating a ratio of these values over time, e.g., a ratio of reads per writes over time or within a time window preceding a time of calculation of the ratio.

The method 800 may include characterizing the cacheability of the application. This may include evaluating such factors as the ratio of reads per writes (a higher ratio of reads means higher cacheability) and labeling of data provided by the application in response to requests (e.g., whether the data is flagged as cacheable, a time to live (TTL) of the data). A cacheability score may be calculated as a function of these factors (a sum, weighted sum, etc.) and compared to one or more thresholds. For example, if the cacheability score is found 808 to be above a first threshold (highly cacheable), the intelligent routing module 402 may program the cloud DNS 404 and intelligent routing module to route access to the application 200a through a plurality of edge clusters 110a-110e. For example, the name and/or domain of the application 200a may be mapped to an Anycast IP address associated with the plurality of edge clusters 110a-110e. Accordingly, requests from each user endpoint 112a-112d will be routed to the edge cluster 110a-110e closest to it, which will have a high likelihood of having requested data to the cacheability of the application instance 200a.

In some embodiments, if the chacheability is found 812 to be below the first threshold but above a second threshold, step 814 is performed, which may be the same as step 810 but for a reduced number of edge clusters 110a-110e. For example, the set of edge clusters 110a-110e associated with the Anycast IP address may be limited to those closest to the application instance 200a relative to those edge clusters 110a-110e that are excluded. In some embodiments, a single threshold is used such that steps 812 and 814 are not performed.

If the cacheability is not found to meet a threshold condition (below the first threshold or below multiple thresholds), then the method 800 may include the intelligent routing module 402 configuring 816 the cloud DNS 404 and/or alternate routing logic 406 such that traffic from each user endpoint 112a-112e and addressed to the application instance 200a will be routed to a single edge cluster 110a, e.g. the edge cluster 110a closest to the application instance 200a or at least in the same regional cloud or the same POP 106a-106c as the application instance 200a. This routing may be according to any of the three lanes described above (cost effective, fast lane, performance) such that traffic may be routed through POPs 106a-106c and the cloud back bone 104 (fast lane), through a POP 106a closest to the edge cluster 110a but not the cloud backbone 104 (performance), or through an ingress location without using a POP 106a or the cloud backbone 104 (cost effective).

For example, to achieve the fast lane, the cloud DNS 402 may be configured such that edge cluster 200a is the only edge cluster associated with an Anycast IP address. Accordingly, all requests addressed to that IP address will be routed by the cloud DNS 402 through a POP 106a-106c closest to the source of the request and through the cloud backbone 104 to the edge cluster 110a.

FIG. 9A illustrates the case of a highly cacheable application instance 200a that is located close to edge cluster 110d (e.g., same POP 106a-106c or same regional cloud). A plurality of edge clusters 110a-110d may include caches 902a-902d. Data from responses to requests transmitted from the application instance 904 may be cached in the caches 902a-902d. The manner in which data is cached, cache hits are identified, and the caches 902a-902d are maintained may be according to any approach known in the art for implementing a cache, such as approaches for caching responses to HTTP content.

A fabric DNS 906 may be a combination of the cloud DNS 404, the intelligent routing module 402, and any alternate routing logic relating to access of the application instance 200a as described above. As is apparent the fabric DNS 906 in the highly cacheable case is configured to route requests to a plurality of edge clusters 110a-110e, such as to the edge cluster 110a-110e nearest to the endpoint 112a-112d that originated the request. Accordingly, if a response to the request is cached, that nearest edge cluster 110a-110e may provide the response without waiting for the application instance 200a.

FIG. 9B illustrates a non-cacheable case in which the fabric DNS 906 is configured to route requests directly to the edge cluster 110e, such as the edge cluster 110e nearest to the application instance 200a. FIG. 9B illustrates the case where traffic is routed to edge cluster 110e over the Internet 108, i.e., the cost effective lane. In other instances, the traffic could be routed over the cloud backbone 104 to implement the fast lane.

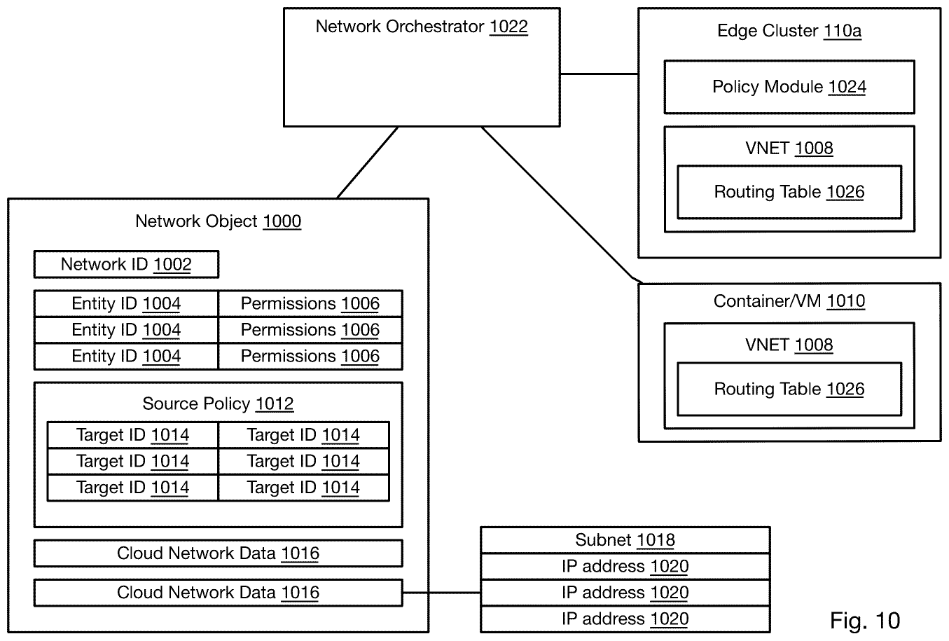

FIG. 10 illustrates a network object 1000 that may be used to facilitate the management of network connectivity and access controls in an efficient manner. The network object 1000 represents a network resource, such as a network, sub-network, IP address, or any other network entity. The network resource represented by the network object 1000 may be a network resource implemented by a cloud computing platform 102. The network object 1000 may represent a plurality of network resources, including network resources in a plurality of cloud computing platforms 102, such as cloud computing platforms 102 that are not affiliated with one another, e.g., MICROSOFT AZURE and AMAZON AWS.

Each network object 1000 may have an entity identifier 1002. The entity identifier 1002 may be a name assigned by a human operator, an automatically assigned identifier that is globally unique to an enterprise, or some other identifier. The entity identifier 1002 may be used by an administrator to manage the network object 1000, such as through the dashboard 114.

For example, an administrator may associate entity identifiers 1004 with the network object 1000. An entity identifier 1004 may refer to an individual user, e.g., a user account, a group of accounts, a particular business unit, or other grouping of users. An entity identifier 1004 may refer to another network object 1000, an edge cluster (e.g., an edge cluster 110a-110e as described above), an application executing within a cloud computing platform 102, or a virtual network (VNET) 1008 executing in an edge cluster 110a or container 1010 (or other execution environment such as a virtual machine).

Each entity identifier 1004 may be granted access to the network resource represented by the network object 1000 upon being added to the network object 1000. In some embodiments, each entity identifier 1004 may additionally or alternatively have permissions 1006 associated therewith. The permissions 1006 associated with an entity identifier 1004 may define permissions such as a portion of a network resource accessible by the entity identified by the entity identifier 1004, read and/or write permissions, permission to perform outbound transmissions from the network resource, permission to receive inbound transmissions from the network resource, or other permissions.

Network connectivity between the network resource identified by the network object 1000 and network resources represented by other network objects 1000 or other networks may be managed by a source policy 1012. The source policy 1012 may include a listing of target identifiers 1014. The target identifier 1014 indicates a network resource to which the network resource represented by the network object 1000 is connected. The target identifier 1014 may therefore be the network identifier 1002 of another network object 1000. For example, to connect one or more first network resources represented by a first network object 1000 to one or more second network resources represented by a second network object 1000, the network identifier 1002 of the first network object 1000 is added to the source policy 1012 of the second network object 1000 and the network identifier of the second network object 1000 is added to the source policy 1012 of the first network object 1000. The target identifier 1014 may also be in the form of an IP address, subnet mask, or other identifier of a network resource that may or may not be represented by a network object 1000. The target identifier 1014 may be for a network object 1000 representing a network resource in a different cloud computing platform than the network object 1000 including the target identifier 1014 in the source policy 1012 thereof.

A network object 1000 may further include cloud network data 1016. The cloud network data 1016 identifies the one or more network resources of one or more cloud computing platforms 102. For example, the cloud network data 1016 may include a subnet 1018 (e.g., subnet mask) allocated by a cloud computing platform 102. The cloud network data 1016 may include IP addresses 1020 allocated by the cloud computing platform 102.

The network objects 1000 of an enterprise may be created and managed by a network orchestrator 1022. For example, the network orchestrator 1022 may manage the allocation of network resources by a cloud computing platform 102 and the creation of a network object 1000 to represent the network resources. The network orchestrator 1022 may therefore be configured with credentials for accessing one or more cloud computing platforms 102, access to records of resources (network resources, storage resources, compute resources, etc.) acquired by an entity for which the network orchestrator 1022 operates, or other information describing accounts of the entity with the one or more cloud computing platforms.

The network orchestrator 1022 may further manage the configuration of edge clusters 110a-110e, containers 1010, or other entities to implement permissions for entities identified by the entity identifiers 1004 of each network object.

In one example, the network orchestrator 1022 configures some or all of the edge clusters 110a-110e by which one or more cloud computing platforms 102 are accessed. For example, each edge cluster 110a-110e may include a policy module 1024 that is programmed by the network orchestrator 1022 to implement each network object 1000. For example, the policy module 1024 may be configured with the entity identifiers 1004 and permissions 1006 of the network object 1000. Accordingly, the edge cluster 110a may receive an input from a requesting entity referencing the network identifier 1002, subnet 1018, IP address 1020, or other identifier of a network resource represented by the network object 1000. If the identifier of the requesting entity does not match any of the entity identifiers 1004 of the network object 1000, i.e., is not authorized, the edge cluster 110a-110e will not route the input to the network resource represented by the network object 1000. The edge cluster 110a-110e may respond to unauthorized requests in various ways. The edge cluster 110a-110e may ignore the request, generate an alert to an administrator, notify the source of the request, reroute the request to a network resource for which the source of the request has permissions according to another network object 1000, or perform other actions.

The input from the requesting entity may request an action such as to connect to a subnetwork represented by the network object 1000, instantiate an application in a subnetwork represented by the network object 1000, communicate with an application executing in a subnetwork represented by the network object 1000, or any other action that requires use of one or more network resources represented by the network object 1000.

As an example, the requesting entity may be a user attempting to access to an application represented by the network object 1000 or located in a VNET represented by the network object 1000. The requesting entity may be located in a first geographic region (e.g., North America) whereas the network object 1000 is in a second geographic region (e.g., Europe) and the first geographic region is or is not granted permissions 1006 in the network object 1000. The requesting entity may be a member of a group or business unit that is or is not granted permissions 1006 in the network object 1000. If the user identifier of the user is therefore not granted permissions 1006 individually, is associated with (e.g., located in) the first geographic region that is not granted permissions 1006, or is associated with a group or business unit that is not granted permissions 1006, the attempt to access the application will be denied. If the user identifier of the user is granted permissions 1006 individually, is associated with (e.g., located in) a geographic region that is granted permissions 1006 (e.g., the first geographic region), or is associated with a group or business unit that is granted permissions, the attempt to access the application will be allowed and the attempt to access will be routed by the edge cluster 110a-110e to the application. A database, application programming interface (API), administrative tool, or any other software module that can execute in a cloud computing platform 102 may have access thereto controlled in a like manner to the application in the example above. Likewise, the access of an application, administrative tool, API, or other software entity may be controlled in a like manner as described above with respect to a user.

The network orchestrator 1022 may further configure software and/or hardware components to perform routing of network traffic according to the source policy 1012. For example, an edge cluster 110a-110e and, some other container 1010, a software or hardware router, or other software or hardware component may include a routing table 1026. The routing table 1026 may be implemented as part of a VNET 1008. The network orchestrator 1022 may configure the routing tables 1026 to route traffic received from a target identifier 1014 of the source policy 1012 and addressed to an IP address 1020 of the network object 1000 to the network resource represented by the network object 1000.

The network orchestrator 1022 may configure the routing tables 1026 of various edge clusters 110a, containers 1010, or other hardware or software components to perform multi-hop routing. For example, an entity represented by a target identifier 1014 and IP address 1020 that are in different subnetworks, different regions of a cloud computing platform 102, or in different cloud computing platforms 102 may be connected by a multi-hop path. The routing tables 1026 of one, two, or more entities may therefore be configured with paths to route packets between the entity represented by a target identifier 1014 and the IP address 1020. A path may be represented using any approach for defining a route as known in the art, such as a next hop assigned to an IP address referring to the IP address or other identifier of another entity to which packets addressed to the IP address are to be forwarded.

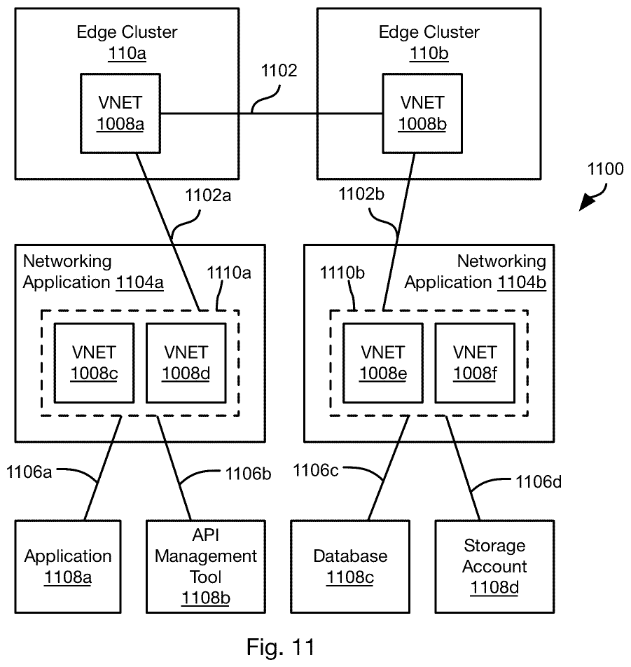

For example, referring to FIG. 11, the network orchestrator 1022 may configure routing tables 1026 to implement the illustrated network hierarchy 1100. The routing tables 1026 may define a path 1102, e.g., a peering path, between edge clusters 110a, 110b that are in the same regional cloud, different regional clouds, or different cloud computing platforms 102. The routing tables 1026 may be defined for VNETs 1008a, 1008b implemented in the edge clusters 110a, 110b.

In another example, one more networking applications 1104a, 1104b execute in one or more regional clouds and in one or more cloud computing platforms 102. The networking applications 1104a, 1104b may be software components programmed to perform networking functions such as routing, load balancing, domain name resolution, or other network functions. Each networking application 1104a, 1104b may implement one or more VNETs 1008c, 1008d, 1008e, 1008f. Groups of VNETs hosted by the same networking application 1104a, 1104b may define subnetworks 1110a, 1110b that may be represented by network objects 1000.

In the illustrated example, the network orchestrator 1022 may configure a network path 1102a between VNET 1008a and the subnetwork 1110a. Likewise, the network orchestrator 1022 may configure a network path 1102b between VNET 1008b and the subnetwork 1110b of the network application 1104b.

The network orchestrator 1022 may configure network paths 1106a, 1106b between the subnetwork 1110a and an application 1108a and/or API management tool 1108b. In another example, the network orchestrator 1022 may configure network paths 1106c, 1106d between the subnetwork 1110b and a database 1108c and/or API storage account 1108d (e.g., cloud-based or other type of data storage account).

In the illustrated example, consider a path between an application 1108a and database 1108c that may be accessed by the application 1108a. The network objects 1000 representing the VNETs 1008a, 1008b, and subnetworks 1110a, 1110b may include source policies 1012 defining a path through the network hierarchy 1100. The network orchestrator 1022 ingests these source policies 1012 of the network hierarchy 1100 and configures the routing tables 1026 and policy modules 1024 of the edge clusters 110a, 110b and VNETs 1008a, 1008b and subnetworks 1110a, 1110b to implement routing between the application 1108a and the database 1108c.

For example, the network objects 1000 representing one or both of the subnetwork 1110b and the application 1108a itself may include one or more target identifiers 1014 referencing one or both of the subnetwork 1110b and the database 1108c itself. The network objects 1000 representing one or both of the subnetwork 1110b and the database 1108c itself may include one or more target identifiers 1014 referencing some or all of the subnetwork 1110a and the application 1108a itself.

In some embodiments, target identifiers 1014 of VNETs 1008a, 1008b that are not directly connected to the application 1108a and database 1108c but form a network path between the entities 1108a-1108d may be either (a) included in the source policies 1012 of the application 1108a and database 1108c and (b) included only in the source policies 1012 of the subnetwork 1110a and the subnetwork 1110b to which the VNETs 1008a, 1008b are directly connected.

As noted above, a single network object 1000 may represent network resources in multiple distinct cloud computing platforms 102. The edge clusters 110a-110e may be configured to facilitate the functioning of these network resources as a single subnetwork. For example, routing tables 1026 of an edge cluster 110a in a first cloud computing platform 102 may be configured with a first address in a second cloud computing platform 102 in order to route traffic addressed to the first address to an edge cluster 110b in the second cloud computing platform 102. The routing table 1026 of the edge cluster 110b in the second cloud computing platform 102 may be configured with a second address in the first cloud computing platform 102 in order to route traffic addressed to the second address to the edge cluster 110a in the first cloud computing platform 102. This configuration is performed automatically without the need for an administrator to do so.

FIGS. 12, 13, and 14 illustrate example methods that may be performed by the network orchestrator 1022. The network orchestrator 1022 itself may be executed by a computing device that is in a cloud computing platform hosting network resources represented by one or more network objects or some other computing device.

Referring to FIG. 12 while still referring to FIG. 11, the illustrated method 1200 may be used to connect entities to one another using network objects 1000. The method 1200 includes creating a 1202 a network object 1000 for one or more network resources, such as any of the VNETs 1008a-1008f and/or entities 1108a-1108d that connect thereto. The network object 1000 may be assigned 1204 one or more IP address of a cloud computing platform 102 hosting the entity and may also be assigned to a subnetwork of the cloud computing platform 102.

Step 1202 may be performed using the dashboard 114. For example, a user may obtain cloud network resources (e.g., IP addresses, subnetworks, domain names, etc.) or discover existing cloud network resources or other network resources (e.g., VNETs, databases, storage resources, etc.) using the dashboard 114. For example, the dashboard 114 may provide an interface for browsing, searching, selecting, naming, or otherwise interacting with representation of network resources of cloud computing platforms 102 for which a network object 1000 may be created. The dashboard 114 may enable a network resource to be created along with a corresponding network object 1000.

The method 1200 may include defining 1206 access privileges by adding entity identifiers 1004 and corresponding permissions 1006 to the network object 1000. Network connectivity to the network resource represented by the network object 1000 may then be implemented by adding 1208 target identifiers 1014 (e.g., IP addresses) of entities to be connected to the network resource represented by the network object 1000 to the source policy 1012 thereof.

Step 1206 may likewise be performed using the dashboard 114. For example, the dashboard 114 may provide an interface for defining roles of entities (e.g., users, groups, and business units), privileges associated with roles (role-based access controls (RBAC), and for the discovery of entities and roles (e.g., search, browse, select, name, etc.). Step 1206 may therefore be performed by a user selecting a role and privileges for a role to be associated with the network object 1000.

The policy modules 1024 of edge clusters 110a-110e may then be updated 1210 according to the permissions 1006 of entity identifiers added to the network object 1000. Note that underlying permissions of the cloud computing platform 102 hosting a network resource represented by the network object 1000 may not be subject to the restrictions imposed by the permissions 1006 and would otherwise grant any entity with access to an account with the cloud computing platform 102 to access the network resource that is associated with the account. The routing tables 1026 of one or more entities may be updated according to the source policy 1012 to establish network connectivity to the network resource managed by the network object 1000.

Steps 1210 and 1212 may be understood with respect to the example network hierarchy 1100 of FIG. 11. For example, the network orchestrator 1022 ingests the source policies 1012 of the entities 1108a-1108d, and possibly the source policies 1012 of intervening entities (e.g., the VNETS 1008a, 1008b), determines that the source policy of a first entity references a second entity (e.g., application 1108a referencing database 1108c and/or source policy 1012 of subnetwork 1110a referencing subnetwork 1110b) and modifies the routing tables 1026 of any intervening entities and possibly the first and/or second entities themselves. In the illustrated example, routing tables 1026 of the subnetwork 1110a are modified to route packets addressed to the database 1108c to an intervening entity, namely, the VNET 1008a, for example. The routing table 1026 of VNET 1008a is modified to route packets addressed to the database 1108c to the VNET 1008b. The routing table 1026 of VNET 1008b is modified to route packets addressed to the database 1108c to the subnetwork 1110b. The routing table 1026 of the subnetwork 1110b is modified to route packets addressed to the database 1108c to the database 1108c

In the opposite direction, the routing table 1026 of subnetwork 1110b is modified to route packets addressed to the application 1108a to VNET 1008b. The routing table of VNET 1008b is modified to route packets addressed to the application 1108a to VNET 1008a. The routing table of VNET 1008a is modified to route packets addressed to the application 1108a to subnetwork 1110a. The routing table of subnetwork 1110a is modified to route packets addressed to the application 1108a to the application 1108a.

The network orchestrator 1022 further modifies policy module 1024 of the edge cluster 110b to permit the application 1108a to access the database 1108c and the VNET 1008e based on inclusion of an entity identifier 1004 of the application 1108a and corresponding permissions 1006 in the network object 1000 for the database 1108c and possibly in the network objects 1000 for the VNET 1008e and VNET 1008b. The network orchestrator 1022 further modifies policy module 1024 of the edge cluster 110a to permit the database 1108c to communicate with the application 1108a and the VNET 1008c based on inclusion of an entity identifier 1004 of the database 1108c and corresponding permissions 1006 in the network object 1000 for the database 1108c and possibly in the network objects 1000 for the VNET 1008e and VNET 1008b.

FIG. 13 illustrates a method 1300 for connecting an entity to one or more network resources represented by one or more network objects 1000. The method 1300 may be performed after a network object 1000 is created and connected to other network resources by modifying routing tables 1026 as described above with respect to the method 1200. The method 1300 may be performed after one or more other entities have already been added to the network object according to the method 1200 or the method 1300. An entity added connected to a network resource may include any of the entities 1108a-1108d, a user account, a group of users, users belonging to a business unit, or users accessing a cloud computing platform from a particular geographic area, i.e., a user endpoint located within a particular geographic area.

The method 1300 may include onboarding 1302 an entity. Onboarding may include receiving information such as an identifier, location, type of device, group identifier, business unit identifier, role identifier, type of application, type of database, or other attribute of the entity to be added. The method 1300 may include assigning 1304 privileges to the entity. The privileges may be assigned manually or automatically. For example, the entity may be assigned privileges associated with the location, group identifier, business unit identifier, role or other attribute of the entity.

The entity may be associated 1306 with one or more network objects 1000, such as by adding an entity identifier 1004 and corresponding privileges from step 1304 to the one or more network objects 1000. Step 1306 may further include modifying the source policies 1012 of the one or more network objects. For example, there may be one or more other entities that are to access or be accessed by the entity. Accordingly, source policies 1012 may be modified for one or more network objects 1000 to establish a network path between the entity and the one or more other entities such as using the approach described above with respect to FIGS. 11 and 12.

The method 1300 may further include updating 1210 policy modules 1024 and updating 1212 routing tables 1026 with respect to the entity added according to the method 1300.

As is apparent the method 1300 is very convenient for an administrator. An administrator need only define the permissions 1006 of an entity and define a connection in a source policy 1012 in order to grant access and establish connectivity. The implementation of the privileges and network connectivity is then managed automatically by the network orchestrator 1022 and the edge clusters 110a-110e.

FIG. 14 illustrates a method 1400 for deleting an entity associated with a network object 1000 or a network object 1000 itself (“the deleted entity”). The method 1400 may include deleting 1402 the entity. Step 1402 may include deleting instances of any of the entities 1108a-1108d, deleting a user account, deleting a VNET, or deleting a data structure defining any entity referenced herein. Where the entity is the network resource represented by the network object 1000 itself, the network object 1000 itself may be deleted.

The method 1400 may include removing 1404 privileges associated with the deleted entity. For example, the policy modules 1024 of one or more edge clusters 110a-110e may be modified to remove privileges associated with an identifier of the deleted entity in the network object 1000. The method 1400 may include deleting 1406 associations of the deleted entity with other network objects 1000. Step 1406 may include deleting references to the entity identifier of the deleted entity from any network objects 1000 including it and/or deleting references to the deleted entity from the source policies 1012 of any network objects 1000 including it. The method 1400 may include updating 1408 routing tables, such as by removing any references to the deleted entity from any routing tables 1026.

The method 1400 has the advantage of requiring an administrator to simply invoke a deletion of an entity with management of deleting privileges and routing information relative to the deleted entity being handled automatically.

Note that in some embodiments, step 1402 omits deletion of the deleted entity itself. Accordingly, the method 1400 may be considered to be the deletion of network connections and privileges of an entity. Note further that an IP address, subnetwork, or other cloud resources (e.g., storage or compute) may continue to exist. However, in the event that these resources are reassigned to a new network object 1000, that network object 1000 may have a new network identifier 1002 and therefore may be treated as a completely different entity than an entity to which the IP address, subnetwork, or other cloud resource was formerly assigned. Accordingly, there is not the possibility of privileges being unintentionally retained from the deleted network object 1000.

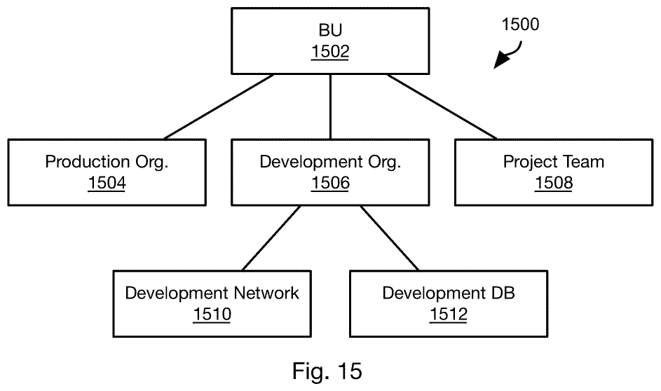

Referring to FIG. 15, permissions to access entities referenced by a network object 1000 or accessible by way of an entity connected by an entity referenced by a network object 1000 may be conveniently managed using a role-based access control (RBAC) hierarchy 1500. The RBAC hierarchy 1500 may include as a root node a business unit 1502, i.e., an object representing a business unit 1502. The business unit may be a department, subsidiary, or other portion of an organization. The business unit 1502 may have objects as descendants, such as objects representing a production organization 1504, a development organization 1506, and a project team 1508.

Each entity may have other entities as descendants, such as entities that are represented by a network object 1000, such as development network 1510 and a development database 1512.

Individual users may be assigned roles associated with any entity in the RBAC hierarchy 1500. A user may be assigned all permissions corresponding to a role for some or all entities in the RBAC hierarchy 1500 or a portion of the RBAC hierarchy, such as an entity and all descendants of that entity.

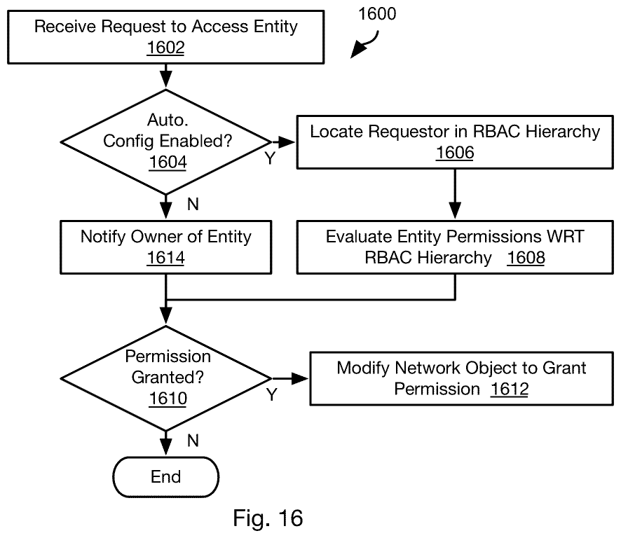

Referring to FIG. 16, the illustrated method 1600 may use a RBAC hierarchy 1500 to automate the granting of permissions to access entities represented by network objects 1000 or accessed by way of an intermediate entity represented by a network object 1000. For example, the method 1600 may include receiving 1602 a request to access an entity 1602 (“the requested entity”). The method 1600 may include evaluating 1604 whether automatic configuration of the requested entity is permitted. If so, the method may include locating 1606 the source of the request in the RBAC hierarchy 1500, e.g., an identifier of a user or other entity that issued the request (“the requestor”).

The method 1600 may include evaluating, at step 1608 permissions associated with the requested entity with respect to the position of the requestor in the RBAC hierarchy 1500. For example, step 1608 may include evaluating whether the requestor is associated with a node in the RBAC hierarchy 1500 that is granted permissions in the network object 1000 representing the requested entity or an intermediate entity through which the requested entity is accessed. In another example, step 1608 may include evaluating whether the requestor is associated with a node in the RBAC hierarchy 1500 is a descendant of the node in the RBAC hierarchy 1500 representing the requested entity or the intermediate entity.

Step 1608 may further include evaluating the permissions granted to the requestor in the RBAC hierarchy 1500, i.e., whether any restrictions are applied to the requestor or whether explicit permissions are granted to the requestor to access the requested entity in the RBAC hierarchy 1500.

If the requestor is found 1610 to be granted permission to access the requested entity or the intermediate entity according to the RBAC hierarchy 1500, the method 1600 may include modifying the network object 1000 for the requested entity or the intermediate entity to grant permissions to the requestor. If not, the method 1600 may end.

In some embodiments, permission may also be granted manually. For example, if automatic configuration is not found 1604 to be enabled, the method 1600 may include notifying 1614 an owner of the requested entity or the intermediate entity. The notification may include identifiers of the requester, requested entity or intermediate entity, information describing the position of the owner in the RBAC hierarch 1500 and/or permissions granted to the requestor in the RBAC 1500. The requestor may respond to the notification by granting or denying permission. If the owner if found 1610 to have granted permission to the requester, then step 1612 may be performed as described above. Otherwise, the method 1600 may end.

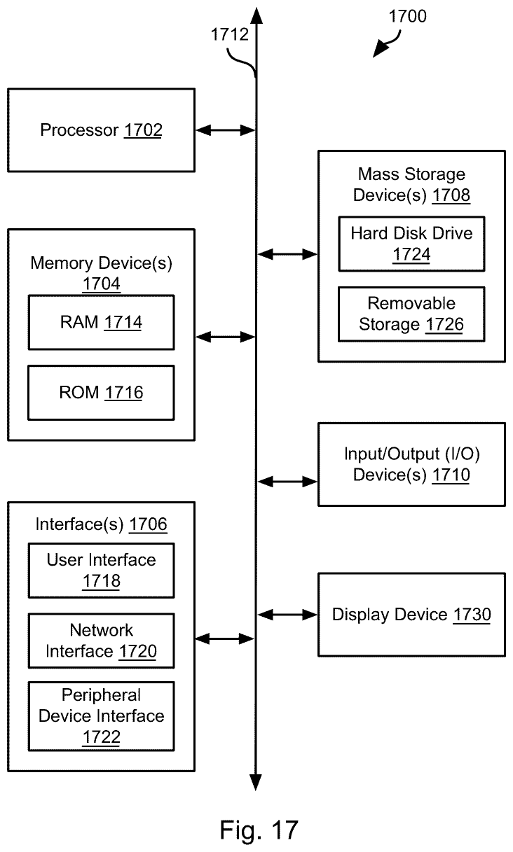

FIG. 17 illustrates an example computing device 1700 that may be used to implement a cloud computing platform or any other computing devices described above. In particular, components described above as being a computer or a computing device may have some or all of the attributes of the computing device 1700 of FIG. 17. FIG. 17 is a block diagram illustrating an example computing device 1700 which can be used to implement the systems and methods disclosed herein

Computing device 1700 includes one or more processor(s) 1702, one or more memory device(s) 1704, one or more interface(s) 1706, one or more mass storage device(s) 1708, one or more Input/Output (I/O) device(s) 1710, and a display device 1730 all of which are coupled to a bus 1712. Processor(s) 1702 include one or more processors or controllers that execute instructions stored in memory device(s) 1704 and/or mass storage device(s) 1708. Processor(s) 1702 may also include various types of computer-readable media, such as cache memory.

Memory device(s) 1704 include various computer-readable media, such as volatile memory (e.g., random access memory (RAM) 1714) and/or nonvolatile memory (e.g., read-only memory (ROM) 1716). Memory device(s) 1704 may also include rewritable ROM, such as Flash memory.

Mass storage device(s) 1708 include various computer readable media, such as magnetic tapes, magnetic disks, optical disks, solid-state memory (e.g., Flash memory), and so forth. As shown in FIG. 17, a particular mass storage device is a hard disk drive 1724. Various drives may also be included in mass storage device(s) 1708 to enable reading from and/or writing to the various computer readable media. Mass storage device(s) 1708 include removable media 1726 and/or non-removable media.

I/O device(s) 1710 include various devices that allow data and/or other information to be input to or retrieved from computing device 1700. Example I/O device(s) 1710 include cursor control devices, keyboards, keypads, microphones, monitors or other display devices, speakers, printers, network interface cards, modems, lenses, CCDs or other image capture devices, and the like.

Display device 1730 includes any type of device capable of displaying information to one or more users of computing device 1700. Examples of display device 1730 include a monitor, display terminal, video projection device, and the like.

Interface(s) 1706 include various interfaces that allow computing device 1700 to interact with other systems, devices, or computing environments. Example interface(s) 1706 include any number of different network interfaces 1720, such as interfaces to local area networks (LANs), wide area networks (WANs), wireless networks, and the Internet. Other interface(s) include user interface 1718 and peripheral device interface 1722. The interface(s) 1706 may also include one or more user interface elements 1718. The interface(s) 1706 may also include one or more peripheral interfaces such as interfaces for printers, pointing devices (mice, track pad, etc.), keyboards, and the like.

Bus 1712 allows processor(s) 1702, memory device(s) 1704, interface(s) 1706, mass storage device(s) 1708, and I/O device(s) 1710 to communicate with one another, as well as other devices or components coupled to bus 1712. Bus 1712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1700, and are executed by processor(s) 1702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
instantiating a plurality of edge clusters on one or more cloud computing platforms, each edge cluster of the plurality of edge clusters being located in a different regional cloud of a plurality of regional clouds in the one or more cloud computing platforms;
receiving, by a computing device, a network object defining a storing (a) a definition of one or more network resources of the one or more cloud computing platforms, (b) network connections between the one or more network resources and one or more entities executing in the one or more cloud computing platforms, and (c) permissions of the one or more entities; and
configuring, by the computing device, the plurality of edge clusters to implement routing of packets according to (b) and grant access to the one or more network resources according to (c).

2. The method of claim 1, wherein the one or more cloud computing platforms are multiple cloud computing platforms and the one or more network resources are multiple network resources of the multiple cloud computing platforms.

3. The method of claim 1, wherein the one or more network resources are internet protocol addresses.

4. The method of claim 1, wherein the one or more network resources are subnetworks.

5. The method of claim 1, wherein the one or more network resources are virtual networks.

6. The method of claim 1, further comprising configuring the plurality of edge clusters to implement the routing of the packets according to (b) by: configuring routing tables in the plurality of edge clusters according to (b).

7. The method of claim 6, further comprising configuring the plurality of edge clusters to implement the routing of the packets according to (b) by: configuring routing tables in one or more virtual networks according to (b).

8. The method of claim 1, further comprising:
receiving, by the computing device, an instruction to delete the network object;
in response to the instruction to delete the network object performing, by the computing device:
configuring the plurality of edge clusters to cease implementing routing of packets according to (b); and
configuring the plurality of edge clusters to cease granting access to the one or more network resources according to (c).

9. The method of claim 1, wherein the one or more entities include at least one of a user account, group of users, business unit, or user endpoints within a geographic area.

10. The method of claim 1, wherein the one or more entities include at least one of an application, a database, a storage resource, or a management tool.

11. A system comprising:
one or more cloud computing platforms comprising a plurality of regional clouds;
a plurality of edge clusters on the one or more cloud computing platforms, each edge cluster being located in a different regional cloud of the one or more cloud computing platforms; and
a network orchestrator coupled to the plurality of edge clusters and programmed to:
receive a network object defining a storing (a) a definition of one or more network resources of the one or more cloud computing platforms, (b) network connections between the one or more network resources and one or more entities executing in the one or more cloud computing platforms, and (c) permissions of the one or more entities; and
configure the plurality of edge clusters to implement routing of packets according to (b) and grant access to the one or more network resources according to (c).

12. The system of claim 11, wherein the one or more cloud computing platforms are multiple cloud computing platforms and the one or more network resources are multiple network resources of the multiple cloud computing platforms.

13. The system of claim 11, wherein the one or more network resources are internet protocol addresses.

14. The system of claim 11, wherein the one or more network resources are subnetworks.

15. The system of claim 11, wherein the one or more network resources are virtual networks.

16. The system of claim 11, wherein the network orchestrator is further programmed to configure the plurality of edge clusters to implement the routing of the packets according to (b) by: configuring routing tables in the plurality of edge clusters according to (b).

17. The system of claim 16, wherein the network orchestrator is further programmed to configure the plurality of edge clusters to implement the routing of the packets according to (b) by: configuring routing tables in one or more virtual networks according to (b).

18. The system of claim 11, wherein the network orchestrator is further programmed to:
receive an instruction to delete the network object;
in response to the instruction to delete the network object:
configure the plurality of edge clusters to cease implementing routing of packets according to (b); and
configure the plurality of edge clusters to cease granting access to the one or more network resources according to (c).

19. The system of claim 11, wherein the one or more entities include at least one of a user account, group of users, business unit, or user endpoints within a geographic area.

20. The system of claim 11, wherein the one or more entities include at least one of an application, a database, a storage resource, or a management tool.
